(19) United States
(12) Patent Application Publication
(10) Pub. No.: US 2026/0267736 A1
(43) Pub. Date: Sep. 10, 2026

(54) Field-Programmable Gate Array Configuration Repair

(71) Applicant: Honeywell International Inc., Charlotte, NC (US)

(72) Inventors: James L. TUCKER, Clearwater, FL (US); Nicholas STROUPE, Odessa, FL (US); AJ KLEINOSOWSKI, Seattle, WA (US); Robert RABE, Chanhassen, MN (US)

(21) Appl. No.: 19/008,424

(22) Filed: Jan. 2, 2025

(51) Int. Cl. G06F 11/10

(52) U.S. Cl. CPC G06F 11/106; G06F 11/1016

(57) ABSTRACT

A supervisor circuit that connects to a field-programmable gate array (FPGA) may send configuration data to the FPGA to enable the FPGA to write the configuration data to configuration memory of the FPGA to configure programmable logic of the FPGA. The supervisor circuit may receive, from the FPGA, an indication of an error, detected during a data scrubbing operation, in the configuration memory of the FPGA. The supervisor circuit may determine, based on the indication of the error, a memory location in the configuration memory that contains the error. The supervisor circuit may send, to the FPGA, error correction data for the memory location to correct the error contained in the memory location.

### STATEMENT REGARDING FEDERALLY SPONSORED RESEARCH OR DEVELOPMENT

This invention was made with Government support under W519TC-23-9-2000 awarded by US Government. The Government has certain rights in the invention.

### TECHNICAL FIELD

The disclosure relates to error correction for memory.

### BACKGROUND

A field-programmable gate array (FPGA) is a type of configurable integrated circuit that include programmable logic blocks that can be programmed and re-programmed in the field to perform various digital functions. A FPGA may, after power up, configure its programmable logic block by writing configuration data into configuration memory of the FPGA. The FPGA may perform data scrubbing operations to check the integrity of the configuration data stored in the configuration memory.

### SUMMARY

In general, this disclosure describes a supervisor circuit that connects to a field-programmable gate array (FPGA) to repair the FPGA's configuration memory by correcting errors in the configuration memory. The supervisor circuit may send configuration data to the FPGA that the FPGA may store in its configuration memory to configure programmable logic in the FPGA.

The FPGA may periodically perform data scrubbing operations to check the integrity of data (e.g., configuration data) stored in the configuration memory. To perform a data scrubbing operation, the FPGA may process memory locations in the configuration memory in sequence and may, for each memory location, read the data from the memory location, check to see whether there are any errors in the data, and attempt to correct errors in the data.

However, in some situations, the FPGA may be unable to correct errors in the configuration memory or may not be able to correct such errors as quickly as may be needed. Because the configuration memory of the FPGA stores configuration data that configures the FPGA's programmable logic to perform one or more functions, errors in the data stored in the configuration memory may cause the programmable logic to perform erroneously and/or in unexpected ways, or may cause the programmable logic to fail. As such, quickly fixing such errors in the configuration memory may reduce the amount of time during which erroneous data in the configuration memory causes programmable logic 106 to perform erroneously and/or to fail.

In accordance with aspects of this disclosure, a supervisor circuit may connect to a FPGA and may be able to more quickly correct errors in the FPGA's configuration memory without disturbing the FPGA's functionality and without having to transition the FPGA to a non-operation state to reload the full contents of the configuration data into the FPGA's configuration memory. The supervisor circuit may include, in the configuration data that is sent to the FPGA, configuration information for configuring the FPGA's programmable logic to implement an error tracking function that tracks data scrubbing operations performed on the FPGA's configuration memory and to, in response to the FPGA detecting an error in the configuration memory, send an indication of the error to the supervisor circuit. The error tracking function may track the elapsed clock cycles since the start of a data scrubbing operation and may, in response to the FPGA detecting an error in the configuration memory, send an indication of the error that includes an indication of the count of the elapsed clock cycles since the start of the data scrubbing operation to the supervisor circuit.

The supervisor circuit may receive, from the FPGA, the indication of the error in the configuration memory that includes the indication of the count of the elapsed clock cycles since the start of the data scrubbing operation to the supervisor circuit. The supervisor circuit may determine, based on the count of the elapsed clock cycles since the start of the data scrubbing operation to the supervisor circuit, a block of configuration data that corresponds to the memory location of the configuration memory that contains the detected error. The supervisor circuit may therefore send the determined block of configuration data to the FPGA, so that the FPGA may overwrite the data in the memory location of the configuration memory that contains the detected error with the block of configuration data, thereby correcting the detected error in the configuration memory.

The techniques of this disclosure provide certain technical advantages. By including, in the configuration data, configuration information that programs the FPGA's programmable logic to implement an error tracking function to track performance of data scrubbing operations, the techniques enable the FPGA to send, to the supervisor circuit, information regarding an error detected in the configuration memory that the supervisor circuit may use to determine the specific memory location in the configuration memory that contains the error.

By determining the specific memory location in the configuration memory that contains the error, the supervisor circuit may be able to determine a specific block of the configuration data that corresponds to the memory location in the configuration memory that contains the error, and may send the block of the configuration data to the FPGA to overwrite the data at the specific memory location to thereby correct the error. In this way, the FPGA may be able to correct an error at a specific memory location in the configuration memory by overwriting the data in the specific memory location with a block of the configuration data, instead of rewriting the entire configuration data to the configuration memory. Because writing a block of data to a specific memory location of the configuration memory may take much less time than rewriting the entire configuration data to the configuration memory, the techniques of this disclosure may be able to more quickly correct errors in configuration memory, thereby reducing the amount of time during which erroneous data in the configuration memory causes programmable logic 106 to perform erroneously and/or to fail.

In some aspects, a supervisor circuit includes: memory that stores configuration data for configuring programmable logic of a field programmable gate array (FPGA); and logic circuitry configured to: send, to the FPGA, the configuration data to enable the FPGA to write the configuration data to configuration memory of the FPGA to configure the programmable logic of the FPGA; receive, from the FPGA, an indication of an error, detected during a data scrubbing operation, in the configuration memory of the FPGA; determine, based on the indication of the error, a memory location in the configuration memory that contains the error; and send, to the FPGA, error correction data for the memory location to correct the error contained in the memory location.

In some examples, a method includes: sending, by a supervisor circuit, configuration data to a field programmable gate array (FPGA) to enable the FPGA to write the configuration data to configuration memory of the FPGA to configure programmable logic of the FPGA; receiving, by the supervisor circuit and from the FPGA, an indication of an error, detected during a data scrubbing operation, in the configuration memory of the FPGA; determining, by the supervisor circuit and based on the indication of the error, a memory location in the configuration memory that contains the error; and sending, by the supervisor circuit and to the FPGA, error correction data for the memory location to correct the error contained in the memory location.

The details of one or more examples of the disclosure are set forth in the accompanying drawings and the description below. Other features, objects, and advantages of the disclosure will be apparent from the description and drawings, and from the claims.

### BRIEF DESCRIPTION OF DRAWINGS

FIG. 1 is a block diagram of an example system that includes a supervisor circuit and a field-programmable gate array (FPGA), in accordance with the techniques of this disclosure.

FIG. 2 is a flow chart illustrating example operations of a supervisor circuit.

### DETAILED DESCRIPTION

The disclosure describes a supervisor circuit configured to perform error correction of data in a field-programmable gate array (FPGA)'s configuration memory. The supervisor circuit may be configured to determine the memory location of errors detected in the FPGA's configuration memory, and may be configured to send error correction data to the FPGA that enables the FPGA to correct the errors in the configuration memory without completely overwriting all of the data stored in the FPGA's configuration memory.

A FPGA may be used in harsh environments, such as in space or high radiation areas. In such harsh environments, the configuration memory of the FPGA, which may include Static Random Access Memory (SRAM) cells, may be sensitive to environmental factors such as radiation (e.g., cosmic rays, alpha particles, etc.) and electrical noise, which may cause single event upsets or other forms of memory corruption.

The FPGA's configuration memory stores configuration data that is used to configure the FPGA's programmable logic to perform various functions. As such, errors in the configuration data stored in a FPGA's configuration memory may cause bugs and unintended behavior in the FPGA's programmable logic. A FPGA may perform data scrubbing operations to check and maintain the integrity of the configuration data stored in the configuration memory. However, in some situations, a FPGA may be unable to correct errors in the configuration memory or may not be able to correct such errors as quickly as may be needed. In some cases, if there are too many uncorrectable errors in the configuration memory, the FPGA may have to completely rewrite the configuration memory with the entire configuration data.

One technique for fixing errors in the data stored in configuration memory includes rewriting configuration memory with a new copy of the configuration data. However, receiving a new copy of configuration data and rewriting configuration memory with the new copy of configuration data may be a lengthy process during which errors in the data stored in configuration memory may continue to cause the FPGA's programmable logic to perform erroneously. Another technique fixing errors in the data stored in configuration memory includes using data scrubbing circuitry to fix errors in the data. However, while the data scrubbing circuitry may be able to fix a small amount of single-bit errors, the data scrubbing circuitry may be unable to fix more complex multi-bit errors or may be unable to fix such complex errors in a timely fashion

In accordance with aspects of this disclosure, a supervisor circuit may send, to the FPGA, configuration data that configures the FPGA's programmable logic to perform an error tracking function to track data scrubbing operations performed on the configuration memory. As the FPGA performs a data scrubbing operation, the error tracking function may track the number of clock cycles that have elapsed since the start of the data scrubbing operation. The error tracking function may track whether the FPGA has detected an error in the configuration memory and may, in response to the FPGA detecting an error in the configuration memory, send, to the supervisor circuit, an indication of the error. The indication of the error may include a count of clock cycles that have elapsed since the start of the data scrubbing operation.

The supervisor circuit may receive, from the FPGA, the indication of the error, which includes a count of clock cycles that have elapsed since the start of the data scrubbing operation and may, based on the count of clock cycles, the memory location of the configuration memory that contains the error. The FPGA may determine a block of configuration data that corresponds to the memory location of the configuration memory that contains the detected error. The supervisor circuit may therefore send the determined block of configuration data to the FPGA, so that the FPGA may overwrite the data in the memory location of the configuration memory that contains the detected error with the block of configuration data, thereby correcting the detected error in the configuration memory.

In this way, the techniques of this invention enable the FPGA to correct errors in the configuration memory by writing blocks of configuration data over the erroneous data without having to completely rewrite the configuration memory with the entire configuration data. The techniques of this invention therefore enables the FPGA to more quickly correct errors in configuration memory, and reduces the amount of time during which the programmable logic is in an erroneous state due to such errors in the configuration memory.

Further, the techniques of this invention also reduce the amount of data that is received by the FPGA to correct errors in configuration memory, as the FPGA may not have to receive the entire configuration data in order to correct errors in the configuration memory by rewriting the configuration memory with the entire configuration data. Instead, the FPGA may only have to receive blocks of the configuration data that correspond to memory locations in the configuration memory containing errors, in order to correct such errors by writing such blocks of the configuration data to those memory locations in the configuration memory.

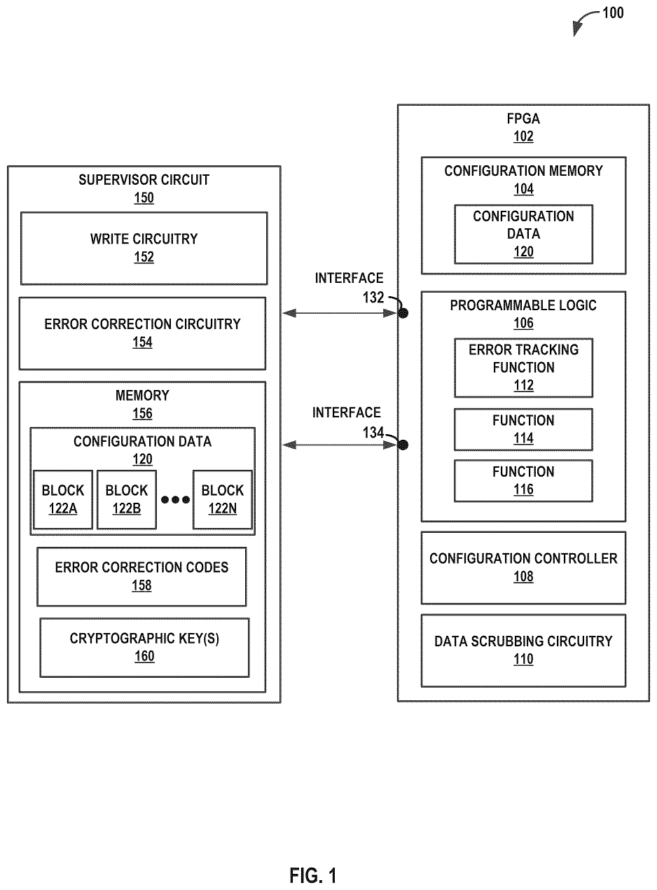

FIG. 1 is a block diagram of an example system 100 that includes a supervisor circuit 150 and field-programmable gate array (FPGA) 102, in accordance with the techniques of this disclosure. System 100 may include additional components not shown in FIG. 1.

Supervisor circuit 150 may include write circuitry 152, error correction circuitry 154, and memory 156. Supervisor circuit 150 may be implemented as an application-specific integrated circuit (ASIC), one or more microcontrollers, or any other suitable form of digital logic. Write circuitry 152 and error correction circuitry 154 may, collectively, be described as logic circuitry.

Memory 156 is configured to store configuration data 120, which includes instructions and data for configuring programmable logic 106 of FPGA 102. Memory 156 may include any suitable memory or storage component, such as random-access memory (RAM), flash memory, or any other suitable volatile or non-volatile memory.

Configuration data 120 may be data that defines how programmable logic 106 is configured. Configuration data 120 may be written in a hardware description language, such as Very High Speed Integrated Circuit Program Hardware Description Language (VHDL), which may be processed to generate configuration data 120. Configuration data 120 may include, in some examples, logic block configurations (e.g., lookup table contents, flip-flop settings, etc.), routing information (e.g., connections between logic blocks), clocking and timing settings, input/output configurations (e.g., pin assignments), and the like.

Write circuitry 152 is configured to write configuration data 120 to FPGA 102. To write configuration data 120 to FPGA 102, write circuitry 152 may send configuration data 120 to FPGA 102 in the form of a bitstream, which is a sequence of bits.

For example, supervisor circuit 150 may be configured to retrieve configuration data 120 from memory 156, encode configuration data 120 into a bitstream, and send the bitstream that encodes configuration data 120, via interface 132, to FPGA 102.

FPGA 102 may include configuration memory 104, programmable logic 106, configuration controller 108, and data scrubbing circuitry 110. FPGA 102 may also include interfaces 132 and 134 to which supervisor circuit 150 may connect to send and receive data to and from FPGA 102.

Interfaces 132 and 134 may provide different amounts of bandwidth for data transfer. In some examples, interface 132 may be referred to as a higher bandwidth interface 132, and interface 134 may be referred to as a lower bandwidth interface 134, because interface 132 may provide a relatively higher amount of bandwidth than interface 134. For example, interface 132 may be a Serial Peripheral Interface (SPI) that may provide up to 100 megabits per second (Mbps) of bandwidth, while interface 134 may be a Joint Test Action Group (JTAG) interface that provides up to 25 Mbps of bandwidth. Supervisor circuit 150 may, in some examples, send a bitstream having configuration data 120 encoded therein via the higher bandwidth interface 132.

Configuration memory 104 is configured to store configuration data used to program programmable logic 106. That is, one or more components of FPGA 102, such as configuration controller 108, may write configuration data into configuration memory 104, which causes programmable logic 106 to be configured according to the configuration data. Configuration memory 104 may be implemented as Static Random Access Memory (SRAM) cells or any other suitable volatile memory.

Configuration controller 108 of FPGA 102 is configured to receive, from supervisor circuit 150 (e.g., via the higher bandwidth interface 132), a bitstream containing configuration data 120. Configuration controller 108 may be configured to extract configuration data 120 from the bitstream and to write configuration data 120 into configuration memory 104 to configure programmable logic 106 to perform one or more operations. For example, configuration controller 108 may write configuration data 120 into configuration memory 104 to configure programmable logic 106 to perform functions 114 and 116 and error tracking function 112. These functions 112, 114, and 116 are discussed in further detail below.

Data scrubbing circuitry 110 is configured to perform data scrubbing of configuration memory 104. Data scrubbing, also referred to as memory scrubbing, is a systematic process of sequentially checking each of a plurality of memory location of configuration memory 104 for errors. The plurality of memory locations may be all or a portion of configuration memory 104 that stores configuration data 120. Each memory location may be a block or a data frame containing one or more bytes of data in configuration memory 104. Data scrubbing circuitry 110 may periodically (e.g., every minute, every 5 minutes, etc.) or continuously perform data scrubbing of configuration memory 104.

During performance of the data scrubbing operation, data scrubbing circuitry 110 may, for each memory location of the plurality of memory locations, read data in the memory location and check whether the data in the memory location contains an error. For example, each memory location of configuration memory 104 stores an error detecting code, such as a cyclic redundancy check (CRC) value, a Hamming code, which is typically used in single-error correcting and double-error detecting (SECDED) applications, and the like. Data scrubbing circuitry 110 may, for data at each memory location, calculate a check value from the data, and compare the calculated check value with the error detecting code (e.g., a CRC value) stored for the memory location. If data scrubbing circuitry 110 determines that the calculated check value does not match the stored error detecting code, data scrubbing circuitry 110 may determine that the data stored in the memory location contains an error.

Because configuration memory 104 stores configuration data 120 that configures programmable logic 106 to perform one or more functions, errors in the data stored in configuration memory 104 may cause programmable logic 106 to perform erroneously and/or to fail. As such, quickly fixing such errors in the data stored in configuration memory 104 may reduce the amount of time during which erroneous data in configuration memory 104 causes programmable logic 106 to perform erroneously and/or to fail.

In accordance with aspects of this disclosure, FPGA 102 is configured to, in response to detecting an error in the memory location of configuration memory 104, send, to supervisor circuit 150, an indication of the error in configuration memory 104. For example, FPGA 102 may send the indication of the error in configuration memory 104 to supervisor circuit 150 via lower bandwidth interface 134. Supervisor circuit 150 is therefore configured to receive, from FPGA 102 (e.g., via lower bandwidth interface 134), an indication of an error in configuration memory 104 of FPGA 102.

In some examples, the indication of the error in configuration memory 104 includes information that supervisor circuit 150 may use to determine a memory location of configuration memory 104 that contains an error. Configuration data 120 may include configuration information that configures programmable logic 106 to include error tracking function 112 that tracks data scrubbing operations performed by data scrubbing circuitry 110. The configuration information may configure error tracking function 112 to, in response to data scrubbing circuitry 110 starting a data scrubbing operation, track (e.g., count) the number of clock cycles that have elapsed since the start of the data scrubbing operation and to track when data scrubbing circuitry 110 has detected an error in configuration memory 104. The configuration information may configure error tracking function 112 to, in response to data scrubbing circuitry 110 detecting an error at a memory location, determine the number of clock cycles that have elapsed since the start of the data scrubbing operation to detect the error at the memory location. In some examples, the configuration information may configure error tracking function 112 to determine the memory location (e.g., data block number) of the error.

Error tracking function 112 may be configured to, in response to determining that data scrubbing circuitry 110 has detected an error in configuration memory 104, send, to supervisor circuit 150 (e.g., via lower bandwidth interface 134), an indication of the number of clock cycles that have elapsed since the start of the data scrubbing operation to detect the error at the memory location. In examples where error tracking function 112 is configured to determine the memory location of the error, error tracking function 112 may be configured to, in response to determining that data scrubbing circuitry 110 has detected an error in configuration memory 104, send, to supervisor circuit 150 (e.g., via lower bandwidth interface 134), an indication of the memory location of the error, such as the data block number associated with the memory location of the error.

Supervisor circuit 150 is configured to receive, from FPGA 102, the indication of the number of clock cycles that have elapsed since the start of the data scrubbing operation to detect the error at the memory location. The number of clock cycles that have elapsed since the start of the data scrubbing operation to detect the error at the memory location is referred to herein as a count of clock cycles that is associated with the memory location where the error was detected.

Configuration data 120 stored in memory 156 of supervisor circuit 150 include blocks 122A-122N (“blocks 122”) of configuration information. Each of blocks 122 has the same size as a memory location in configuration memory 104 of FPGA 102. For example, if each memory location in configuration memory 104 is eight bytes, each of blocks 122 may correspondingly be a block of eight bytes.

Each block of blocks 122 corresponds to a memory location in configuration memory 104. That is, each block of blocks 122 contains the same portion of configuration data 120 as is stored in a corresponding memory location of configuration memory 104. In some example, each block of blocks 122 correspond to a memory location in configuration memory 104 that is in the same ordinal position in the sequence of memory locations in configuration memory 104 as the block is in the sequence of blocks 122. For example, if each of blocks 122 and memory location has a size of n bytes, the first block 122A of blocks 122 may span the 0^{th} byte to the n-1th byte in blocks 122, the second block 122B of blocks 122 may span the nth byte to the 2*n-1th byte in blocks 122, and the like. Similarly, the first memory location in the sequence of memory locations in configuration memory 104 may span the 0^{th} byte to the n-1th byte in configuration memory 104, the second memory location in the sequence of memory locations in configuration memory 104 may span the nth byte to the 2*n-1th byte in configuration memory 104, and the like.

Error correction circuitry 154 of supervisor circuit 150 is configured to determine, based on the count of clock cycles, the associated memory location of configuration memory 104 containing the detected error. Error correction circuitry 154 may map the associated memory location of configuration memory 104 containing the detected error to a block of configuration data 120 out of blocks 122.

Error correction circuitry 154 may determine based on the count of clock cycles, the associated memory location in configuration memory 104 by dividing the count of clock cycles by the number of clock cycles per memory location associated with FPGA 102. The number of clock cycles per memory location may be the number of clock cycles it takes for data scrubbing circuitry 110 to scrub a single memory location of a sequence of memory locations of configuration memory 104. For example, if it takes data scrubbing circuitry 110 eight clock cycles to scrub through four memory locations in configuration memory 104, the number of clock cycles per memory location may be two, which is the result of dividing eight clock cycles by four memory locations. Thus, if the count of clock cycles is ten clock cycles, and if the number of clock cycles per memory location is two, then the count of clock cycles is associated with a fifth memory location of configuration memory 104, which is the result of dividing ten clock cycles by two.

Error correction circuitry 154 may be configured to determine the number of clock cycles per memory location associated with FPGA 102 by injecting an intentional error into configuration data 120 that is written to configuration memory 104. That is, error correction circuitry 154 may insert data into a specific block in configuration data 120 written to configuration memory 104 that would cause data scrubbing circuitry 110 to detect the intentional error at a specific memory location in configuration memory 104 that corresponds to the specific block in configuration data 120. For example, error correction circuitry 154 may inject an intentional error into data in the sequentially 5^{th} memory location in configuration memory 104 by injecting the intentional error into the sequentially 5^{th} block of blocks 122 of configuration data 120 retrieved from memory 156.

Error correction circuitry 154 may inject an intentional error into a specific block in configuration data 120, and write circuitry 152 may send configuration data 120 having the injected error to FPGA 102 (e.g., via higher bandwidth interface 132) to write into configuration memory 104. In another example, error correction circuitry 154 may inject an intentional error into a specific block in configuration data 120, and write circuitry 152 may send a block of configuration data 120 having the injected error to FPGA 102 (e.g., via lower bandwidth interface 134) to write the block of configuration data 120 into a corresponding memory location of configuration memory 104.

In some examples, error correction circuitry 154 may inject an intentional error in the error detecting code associated with a specific memory location, such as by changing the error detecting code from a code that would match a check value calculated for error-free data in the memory location to a code that would not match the check value calculated for error-free data in the memory location, or by injecting the intentional error at a memory location that is not used to store configuration data 120. Thus, when data scrubbing circuitry 110 performs data scrubbing of configuration memory 104, data scrubbing circuitry 110 may determine that the error detecting code does not match the check value calculated for data in the memory location, and may therefore detect an error at the memory location. In the approaches described above, injecting the intentional error in a memory location not used to store configuration data 120 or injecting the intentional error by changing the error detecting code may not affect the functionality of FPGA 102 and may not affect the actual configuration data 120 stored in configuration memory 104.

Subsequent to the intentional error being injected into configuration data 120 in configuration memory 104, data scrubbing circuitry 110 may perform a data scrubbing operation on configuration memory 104. As data scrubbing circuitry 110 performs the data scrubbing operation, programmable logic 106 may count the number of cycles since the start of the data scrubbing operation for data scrubbing circuitry 110 to scrub the memory location having the injected error and may send, to supervisor circuit 150 (e.g., via lower bandwidth interface 134), an indication of the number of clock cycles that have elapsed since the start of the data scrubbing operation to detect the injected error, which is referred to herein as a count of clock cycles that is associated with the memory location having the injected error.

Supervisor circuit 150 is configured to receive, from FPGA 102, the indication of the count of clock cycles that is associated with the memory location having the injected error. Error correction circuitry 154 may determine a mapping of clock cycle counts to memory locations in configuration memory 104 based on the count of clock cycles that is associated with the memory location having the injected error. In some examples, error correction circuitry 154 may divide the count of clock cycles that is associated with the memory location having the injected error by the ordinal position of the memory location containing the injected error in the sequence of memory locations in configuration memory 104 to determine a number of clock cycles per memory location for FPGA 102.

For example, if the count of clock cycles that is associated with the memory location having the injected error (if the memory locations of configuration memory 104 starts at a first memory location) is eight clock cycles, and if the memory location having the injected error is a fourth memory location of the sequence of memory locations in configuration memory 104, error correction circuitry 154 may determine the number of clock cycles per memory location to be two clock cycles, which is the result of dividing eight clock cycles by the fourth memory location.

Supervisor circuit 150 is configured to send (e.g., via lower bandwidth interface 134), to FPGA 102, error correction data for the memory location that enables FPGA 102 to correct the error in the memory location. In some examples, supervisor circuit 150 may send, to FPGA 102, a block of configuration data 120 that corresponds to the memory location of the error, so that FPGA 102 may overwrite the memory location in configuration memory 104 with the block of configuration data 120 received from supervisor circuit 150.

To send a block of configuration data 120 that corresponds to the memory location of the error to FPGA 102, error correction circuitry 154 may be configured to retrieve, from memory 156, a block of configuration data 120 out of blocks 122 that corresponds to the memory location of the error in configuration memory 104 and send the block of configuration data 120 to FPGA 102. As described above, each block of blocks 122 corresponds to a memory location in configuration memory 104.

In some examples, supervisor circuit 150 may store configuration data 120 in encrypted form in memory 156, and error correction circuitry 154 is configured to decrypt configuration data 120 to retrieve the block of configuration data 120 that corresponds to the memory location of the error. For example, supervisor circuit 150 may store one or more cryptographic keys 160 in memory 156 that includes a decryption key for decrypting configuration data 120. Error correction circuitry 154 may retrieve, from one or more cryptographic keys 160 in memory 156, a decryption key for decrypting configuration data 120, decrypt configuration data 120 using the decryption key, and retrieve an unencrypted block of configuration data 120 that corresponds to the memory location of the error.

In some example, different blocks of configuration data 120 is encrypted using different encryption keys. For example, each block of blocks 122 of configuration data 120 is encrypted using a different encryption key and may therefore be decrypted using a corresponding decryption key. One or more cryptographic keys 160 in memory 156 may include, for each of blocks 122, a corresponding decryption key for decrypting the block. Error correction circuitry 154 may retrieve, from one or more cryptographic keys 160 in memory 156, a decryption key for decrypting a block of blocks 122 that corresponds to the memory location of the error, decrypt the block using the decryption key, and retrieve the unencrypted block of configuration data 120 that corresponds to the memory location of the error.

In some examples, each block of blocks 122 of configuration data 120 may be associated with a criticality levels. Examples of such criticality levels may be a low criticality level, a medium criticality level, or a high criticality level. A criticality level of a block may indicate the level of importance of the logic configured in programmable logic 106 by the block of configuration data 120. For example, blocks of configuration data 120 that configures programmable logic 106 to implement error tracking function 112 may each be associated with a high criticality level, while other blocks of configuration data may be associated with a medium criticality level or a low criticality level.

As described above, error correction circuitry 154 may map a memory location in configuration memory 104 to a block of blocks 122. Thus, error correction circuitry 154 may be able to determine, for a memory location of configuration memory 104 that contains an error, a criticality level of the memory location as the criticality level of the corresponding block of blocks 122 of configuration data 120.

Error correction circuitry 154 may use the criticality level of a memory location that contains an error to determine how to correct the error in the memory location. In some examples, if error correction circuitry 154 determines that the criticality level of a memory location that contains an error is high, error correction circuitry 154 may determine to re-write configuration memory 104 with a new copy of configuration data 120 rather than write a corresponding block of configuration data 120 to the memory location in configuration memory 104.

In some examples, the indication of an error in configuration memory 104 received by supervisor circuit 150 from FPGA 102 may also include the data stored in the memory location. That is, error tracking function 112 or data scrubbing circuitry 110 may be configured to, in response to data scrubbing circuitry 110 detecting an error at a memory location in configuration memory 104, send (e.g., via lower bandwidth interface 134) the data stored in the memory location where the error was detected to supervisor circuit 150.

Supervisor circuit 150 may receive, from FPGA 102 (e.g., via lower bandwidth interface 134), a block of data (e.g., a plurality of bytes) stored in the memory location of configuration memory 104 where the error was detected. Error correction circuitry 154 may correct the error in the block of data and may send (e.g., via lower bandwidth interface 134) the corrected data to FPGA 102 for writing into the same memory location of configuration memory 104.

Supervisor circuit 150 is configured to store, in memory 156, error correction codes 158 that include a corresponding correction code for each of blocks 122 of configuration data 120. Examples of error correction codes may include triple modular redundancy codes, Hamming codes, Nordstrom-Robinson codes, Golay codes, Bose-Chaudhuri-Hocquenghem (BCH) codes, or any other suitable error correction codes that can be used to correct errors in data.

As describe above, each memory location in configuration memory 104 of FPGA 102 may be mapped to a specific block of blocks 122 of configuration data 120. Error correction circuitry 154 may retrieve, from error correction codes 158, the error corresponding correction code for the block of configuration data 120 that corresponds to the memory location of the error in configuration memory 104. Error correction circuitry 154 may use the retrieved error correction code to perform error correction of the block of data stored in the memory location via any suitable technique.

Error correction circuitry 154 may therefore perform error correction of the block data in the memory location by correcting one or more bytes of the data in the memory location, as received from FPGA 102, based on the retrieved error correction code, to generate a corrected block of data for the memory location. Error correction circuitry 154 may send (e.g., via lower bandwidth interface 134) the corrected block of data to FPGA 102 to write the corrected block of data to the memory location in configuration memory 104.

In some examples, performing error correction of the block of data stored in the memory location may include correcting fewer than all of the bytes in the block of data. For example, error correction circuitry 154 may correct one or more bytes in the block of data, out of a plurality of bytes in the block of data, to generate one or more corrected bytes. Instead of sending the entire corrected block of data to FPGA 102, error correction circuitry 154 may send the one or more corrected bytes of the block of data (e.g., via lower bandwidth interface 134) to FPGA 102 to write the one or more corrected bytes of the block of data to the memory location in configuration memory 104.

In some examples, error tracking function 112 may include functionality that enables supervisor circuit 150 to determine whether error tracking function 112 has been corrupted or is otherwise not functioning properly. Error tracking function 112 may be configured to periodically send a heartbeat to supervisor circuit 150 that enables supervisor circuit 150 to determine whether error tracking function 112 is functioning correctly.

Error tracking function 112 may be configured to send a heartbeat according to a periodic schedule, such as every 30 seconds, every minute, and the like. Each heartbeat sent by error tracking function 112 may specify a value, such as a numerical value, which supervisor circuit 150 may be able to check to determine whether error tracking function 112 working correctly. Error tracking function 112 may change values specified by sequential heartbeats according to a pattern of values, such as by incrementing values specified by sequential heartbeats by a specific value, such as by 1. That is, error tracking function 112 may be configured to initially send a heartbeat having a value of 1, send a subsequent heartbeat having a value of 2, send a subsequent heartbeat having a value of 3, and so on.

Supervisor circuit 150 may periodically receive a heartbeat from FPGA 102 (e.g., via lower bandwidth interface 134), and error correction circuitry 154 may determine, based on the heartbeats received from FPGA 102, whether error tracking function 112 has been corrupted. If error correction circuitry 154 fails to receive a heartbeat from FPGA 102 according to the periodic schedule (e.g., every 30 seconds), error correction circuitry 154 may determine that error tracking function 112 has been corrupted.

In some examples, error correction circuitry 154 may determine whether the value specified by a heartbeat received from FPGA 102 is indicative of error tracking function 112. Error correction circuitry 154 may determine whether the value specified by a heartbeat is an unexpected value, such as by determining whether the value specified by the heartbeat correspond to an expected value according to the pattern of values. For example, if the pattern of values specifies that a value specified by a heartbeat is incremented by 1 from the value specified by the previous heartbeat in the sequence of heartbeats, error correction circuitry 154 may determine that the value specified by the heartbeat correspond to an expected value if the value specified by the heartbeat is not incremented by 1 from the value specified by the previous heartbeat in the sequence of heartbeats. If error correction circuitry 154 determines that the value specified by a heartbeat is an unexpected value, error correction circuitry 154 may determine that error tracking function 112 has been corrupted.

Error correction circuitry 154 may, in response to determining that error tracking function 112 has been corrupted, take one or more remedial actions. In some examples, supervisor circuit 150 may communicate with FPGA 102 to cause FPGA 102 to overwrite configuration data 120 stored in configuration memory 104 with configuration data 120 stored in memory 156 of supervisor circuit 150. That is, write circuitry 152 may communicate with FPGA 102 to write configuration data 120 stored in memory 156 of supervisor circuit 150 to configuration memory 104, thereby rewriting configuration memory 104 with a new copy of configuration data 120.

In some examples, configuration data 120 in configuration memory 104 may configure programmable logic 106 to include redundant functions. That is, configuration data 120 may configure programmable logic 106 to include separate logic blocks that are programmed to perform the same function. As shown in FIG. 1, configuration data 120 may configure programmable logic 106 to include function 114 and function 116 that perform the same function, such as the same image processing function. Functions 114 and 116 are redundant functions because only one of functions 114 and 116 may be active at a time to perform its programmed function.

FPGA 102 may be configured to control activation and deactivation of redundant functions 114 and 116 based on errors detected in configuration memory 104. In the example where function 114 is active and function 116 is inactive, error tracking function 112 may be configured to track the errors detected in memory locations of configuration memory 104 containing configuration information for function 114, such as errors detected during a data scrubbing operation performed by data scrubbing circuitry 110. Error tracking function 112 may, based on the number of errors detected in memory locations of configuration memory 104 containing configuration information for function 114 being above an error threshold, such as 10 bits having errors, 20 bits having errors, and the like, deactivate function 114 and activate function 116. While function 114 is deactivated, FPGA 102 in conjunction with supervisor circuit 150 may correct the errors in the memory locations of configuration memory 104 containing configuration information for function 114, according to the techniques of this disclosure.

Similarly, when function 116 is active and function 114 is inactive, error tracking function 112 may be configured to track the errors detected in memory locations of configuration memory 104 containing configuration information for function 116, such as errors detected during a data scrubbing operation performed by data scrubbing circuitry 110. Error tracking function 112 may, based on the number of errors detected in memory locations of configuration memory 104 containing configuration information for function 116 being above the error threshold, deactivate function 116 and activate function 114. While function 116 is deactivated, FPGA 102 in conjunction with supervisor circuit 150 may correct the errors in the memory locations of configuration memory 104 containing configuration information for function 116, according to the techniques of this disclosure. In this way, FPGA 102 may be able to reduce downtime for FPGA 102 that may be needed to correct errors in configuration memory 104.

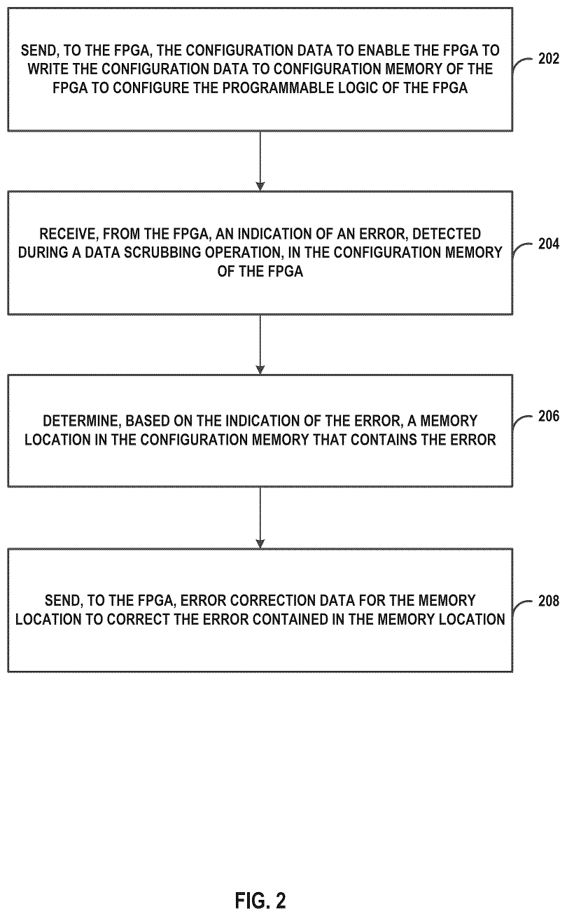

FIG. 2 is a flow chart illustrating example operations of a supervisor circuit 150. FIG. 2 is described with respect to FIG. 1.

As shown in FIG. 2, supervisor circuit 150 may send configuration data 120 to a field-programmable gate array (FPGA) 102 to enable the FPGA 102 to write the configuration data 120 to configuration memory 104 of the FPGA 102 to configure programmable logic 106 of the FPGA 102 (202). Supervisor circuit 150 may receive, from the FPGA 102, an indication of an error, detected during a data scrubbing operation, in the configuration memory 104 of the FPGA 102 (204).

In some examples, the configuration data 120 includes configuration information for configuring the programmable logic 106 of the FPGA 102 to include an error tracking function 112 configured to track elapsed clock cycles since a start of the data scrubbing operation and to, in response to detecting the error in the configuration memory 104 during the data scrubbing operation, send, to the supervisor circuit 150, the indication of the error in the configuration memory 104 of the FPGA 102 that includes an indication of a clock cycle count indicative of the elapsed clock cycles since the start of the data scrubbing operation.

In some examples, the error tracking function 112 is further configured to periodically send a heartbeat to the supervisor circuit 150. Supervisor circuit 150 may determine, based on the heartbeat received from the FPGA 102, that the error tracking function 112 has been corrupted and may, in response to determining that the error tracking function 112 has been corrupted, send, to the FPGA 102, the configuration data 120 to enable the FPGA 102 to rewrite the configuration data 120 to the configuration memory 104 of the FPGA 102 to reconfigure the programmable logic 106 of the FPGA 102.

In some examples, to determine, based on the clock cycle count, the memory location in the configuration memory 104 that contains the error, supervisor circuit 150 may determine, based on the clock cycle count and a number of clock cycles per memory location associated with FPGA 102, the memory location in the configuration memory 104 that contains the error. In some examples, to determine, based on the clock cycle count and the number of clock cycles per memory location associated with FPGA 102, the memory location in the configuration memory 104 that contains the error, supervisor circuit 150 may determine, based on dividing the clock cycle count by the number of clock cycles per memory location associated with the FPGA 102, the memory location in the configuration memory 104 that contains the error.

In some examples, supervisor circuit 150 may inject an intentional error in a specific memory location of the configuration memory 104. Supervisor circuit 150 may, in response to injecting the intentional error in the specific memory location of the configuration memory 104, receive, from the FPGA 102, a second clock cycle count indicative of elapsed clock cycles since a start of a second data scrubbing operation that detected the intentional error in the configuration memory 104. Supervisor circuit 150 may determine the number of clock cycles per memory location associated with the FPGA 102 based on the second clock cycle count and the specific memory location of the configuration memory 104. In some examples, to inject the intentional error in the specific memory location of the configuration memory 104, supervisor circuit 150 may inject the intentional error in an error detecting code associated with the specific memory location of the configuration memory 104.

In some examples, the indication of the error in the configuration memory 104 of the FPGA 102 comprises data stored in the memory location, and to send, to the FPGA 102, the error correction data for the memory location, supervisor circuit 150 may determine a block of the configuration data 120 stored in the memory 156 that corresponds to the memory location. Supervisor circuit 150 may determine an error correction code for the data stored in the memory location. Supervisor circuit 150 may perform, using the error correction code, error correction of the data stored in the memory location to generate corrected data for the memory location. Supervisor circuit 150 may send the corrected data for the memory location to the FPGA 102 to enable the FPGA 102 to write the corrected data for the memory location to the memory location in the configuration memory 104.

Supervisor circuit 150 may determine, based on the indication of the error, a memory location in the configuration memory 104 that contains the error (206). In some examples, to determine, based on the indication of the error, the memory location of the error, supervisor circuit 150 may determine, based on the clock cycle count, the memory location in the configuration memory 104 that contains the error.

Supervisor circuit 150 may send, to the FPGA 102, error correction data for the memory location to correct the error contained in the memory location (208). In some examples, to send, to the FPGA 102, the error correction data for the memory location, supervisor circuit 150 may determine a block of the configuration data 120 stored in the memory 156 that corresponds to the memory location and may send the block of the configuration data 120 stored in the memory 156 that corresponds to the memory location to the FPGA 102 to enable the FPGA 102 to write the block of the configuration data stored in memory 156 to the memory location in the configuration memory 104.

The techniques of this disclosure may also be described in the following clauses.

Clause 1. A supervisor circuit comprising: memory that stores configuration data for configuring programmable logic of a field programmable gate array (FPGA); and logic circuitry configured to: send, to the FPGA, the configuration data to enable the FPGA to write the configuration data to configuration memory of the FPGA to configure the programmable logic of the FPGA; receive, from the FPGA, an indication of an error, detected during a data scrubbing operation, in the configuration memory of the FPGA; determine, based on the indication of the error, a memory location in the configuration memory that contains the error; and send, to the FPGA, error correction data for the memory location to correct the error contained in the memory location.

Clause 2. The supervisor circuit of clause 1, wherein the configuration data includes configuration information for configuring the programmable logic of the FPGA to include an error tracking function configured to track elapsed clock cycles since a start of the data scrubbing operation and to, in response to detecting the error in the configuration memory during the data scrubbing operation, send, to the supervisor circuit, the indication of the error in the configuration memory of the FPGA that includes an indication of a clock cycle count indicative of the elapsed clock cycles since the start of the data scrubbing operation.

Clause 3. The supervisor circuit of clause 2, wherein the error tracking function is further configured to periodically send a heartbeat to the supervisor circuit, wherein the logic circuitry is further configured to: determine, based on the heartbeat received from the FPGA, that the error tracking function has been corrupted; and in response to determining that the error tracking function has been corrupted, send, to the FPGA, the configuration data to enable the FPGA to rewrite the configuration data to the configuration memory of the FPGA to reconfigure the programmable logic of the FPGA.

Clause 4. The supervisor circuit of any of clauses 2 and 3, wherein to determine, based on the indication of the error, the memory location of the error, the logic circuitry is further configured to determine, based on the clock cycle count, the memory location in the configuration memory that contains the error.

Clause 5. The supervisor circuit of clause 4, wherein to send, to the FPGA, the error correction data for the memory location, the logic circuitry is configured to: determine a block of the configuration data stored in the memory that corresponds to the memory location; and send the block of the configuration data stored in the memory that corresponds to the memory location to the FPGA to enable the FPGA to write the block of the configuration data stored in memory to the memory location in the configuration memory.

Clause 6. The supervisor circuit of any of clauses 4 and 5, wherein to determine, based on the clock cycle count, the memory location in the configuration memory that contains the error, the logic circuitry is further configured to: determine, based on the clock cycle count and a number of clock cycles per memory location associated with FPGA, the memory location in the configuration memory that contains the error.

Clause 7. The supervisor circuit of clause 6, wherein to determine, based on the clock cycle count and the number of clock cycles per memory location associated with FPGA, the memory location in the configuration memory that contains the error, the logic circuitry is further configured to: determine, based on dividing the clock cycle count by the number of clock cycles per memory location associated with the FPGA, the memory location in the configuration memory that contains the error.

Clause 8. The supervisor circuit of any of clauses 6 and 7, wherein the logic circuitry is further configured to: inject an intentional error in a specific memory location of the configuration memory; in response to injecting the intentional error in the specific memory location of the configuration memory, receive, from the FPGA, a second clock cycle count indicative of elapsed clock cycles since a start of a second data scrubbing operation that detected the intentional error in the configuration memory; and determine the number of clock cycles per memory location associated with the FPGA based on the second clock cycle count and the specific memory location of the configuration memory.

Clause 9. The supervisor circuit of clause 8, wherein to inject the intentional error in the specific memory location of the configuration memory, the logic circuitry is configured to: inject the intentional error in an error detecting code associated with the specific memory location of the configuration memory.

Clause 10. The supervisor circuit of any of clauses 4-9, wherein the indication of the error in the configuration memory of the FPGA comprises data stored in the memory location, and wherein to send, to the FPGA, the error correction data for the memory location, the supervisor circuit is configured to: determine a block of the configuration data stored in the memory that corresponds to the memory location; determine an error correction code for the data stored in the memory location; perform, using the error correction code, error correction of the data stored in the memory location to generate corrected data for the memory location; and send the corrected data for the memory location to the FPGA to enable the FPGA to write the corrected data for the memory location to the memory location in the configuration memory.

Clause 11. A method comprising: sending, by a supervisor circuit, configuration data to a field programmable gate array (FPGA) to enable the FPGA to write the configuration data to configuration memory of the FPGA to configure programmable logic of the FPGA; receiving, by the supervisor circuit and from the FPGA, an indication of an error, detected during a data scrubbing operation, in the configuration memory of the FPGA; determining, by the supervisor circuit and based on the indication of the error, a memory location in the configuration memory that contains the error; and sending, by the supervisor circuit and to the FPGA, error correction data for the memory location to correct the error contained in the memory location.

Clause 12. The method of clause 11, wherein the configuration data includes configuration information for configuring the programmable logic of the FPGA to include an error tracking function configured to track elapsed clock cycles since a start of the data scrubbing operation and to, in response to detecting the error in the configuration memory during the data scrubbing operation, send, to the supervisor circuit, the indication of the error in the configuration memory of the FPGA that includes an indication of a clock cycle count indicative of the elapsed clock cycles since the start of the data scrubbing operation.

Clause 13. The method of clause 12, wherein the error tracking function is further configured to periodically send a heartbeat to the supervisor circuit, further comprising: determining, by the supervisor circuit and based on the heartbeat received from the FPGA, that the error tracking function has been corrupted; and in response to determining that the error tracking function has been corrupted, sending, by the supervisor circuit and to the FPGA, the configuration data to enable the FPGA to rewrite the configuration data to the configuration memory of the FPGA to reconfigure the programmable logic of the FPGA.

Clause 14. The method of any of clauses 12 and 13, wherein determining, based on the indication of the error, the memory location of the error further comprises: determining, by the supervisor circuit and based on the clock cycle count, the memory location in the configuration memory that contains the error.

Clause 15. The method of clause 14, wherein sending, to the FPGA, the error correction data for the memory location further comprises: determining, by the supervisor circuit, a block of the configuration data stored in the memory that corresponds to the memory location; and sending, by the supervisor circuit, the block of the configuration data stored in the memory that corresponds to the memory location to the FPGA to enable the FPGA to write the block of the configuration data stored in memory to the memory location in the configuration memory.

Clause 16. The method of any of clauses 14 and 15, wherein determining, based on the clock cycle count, the memory location in the configuration memory that contains the error further comprises: determining, by the supervisor circuit and based on the clock cycle count and a number of clock cycles per memory location associated with FPGA, the memory location in the configuration memory that contains the error.

Clause 17. The method of clause 16, wherein determining, based on the clock cycle count and the number of clock cycles per memory location associated with FPGA, the memory location in the configuration memory that contains the error further comprises: determining, by the supervisor circuit and based on dividing the clock cycle count by the number of clock cycles per memory location associated with the FPGA, the memory location in the configuration memory that contains the error.

Clause 18. The method of any of clauses 16 and 17, further comprising: injecting, by the supervisor circuit, an intentional error in a specific memory location of the configuration memory; in response to injecting the intentional error in the specific memory location of the configuration memory, receiving, by the supervisor circuit and from the FPGA, a second clock cycle count indicative of elapsed clock cycles since a start of a second data scrubbing operation that detected the intentional error in the configuration memory; and determining, by the supervisor circuit, the number of clock cycles per memory location associated with the FPGA based on the second clock cycle count and the specific memory location of the configuration memory.

Clause 19. The method of clause 18, wherein injecting the intentional error in the specific memory location of the configuration memory further comprises: injecting, by the supervisor circuit, the intentional error in an error detecting code associated with the specific memory location of the configuration memory.

Clause 20. The method of any of clauses 14-19, wherein the indication of the error in the configuration memory of the FPGA comprises data stored in the memory location, and wherein sending, to the FPGA, the error correction data for the memory location further comprises: determining, by the supervisor circuit, a block of the configuration data stored in the memory that corresponds to the memory location; determining, by the supervisor circuit, an error correction code for the data stored in the memory location; performing, by the supervisor circuit and using the error correction code, error correction of the data stored in the memory location to generate corrected data for the memory location; and sending, by the supervisor circuit, the corrected data for the memory location to the FPGA to enable the FPGA to write the corrected data for the memory location to the memory location in the configuration memory.

Clause 21. The supervisor circuit of clause 5, wherein the memory stores the configuration data in decrypted form, and wherein to send the block of the configuration data to the FPGA, the logic circuitry is further configured to: decrypt, using a decryption key that corresponds to the block of the configuration data, the block of the configuration data stored in the memory that corresponds to the memory location.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that may be accessed by one or more computers or one or more processors to retrieve instructions, code and/or data structures for implementation of the techniques described in this disclosure. A computer program product may include a computer-readable medium.

By way of example, and not limitation, such computer-readable storage media may comprise RAM, ROM, EEPROM, CD-ROM or other optical disk storage, magnetic disk storage, or other magnetic storage devices, flash memory, or any other storage medium that may be used to store desired program code in the form of instructions or data structures and that may be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used herein, includes compact disc (CD), laser disc, optical disc, digital versatile disc (DVD), floppy disk and Blu-ray disc, where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used herein may refer to any of the foregoing structures or any other structure suitable for implementation of the techniques described herein. In addition, in some aspects, the functionality described herein may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of intraoperative hardware units, including one or more processors as described above, in conjunction with suitable software and/or firmware.

It is to be recognized that, depending on the example, certain acts or events of any of the techniques described herein may be performed in a different sequence, may be added, merged, or left out altogether (e.g., not all described acts or events are necessary for the practice of the techniques). Moreover, in certain examples, acts or events may be performed concurrently, e.g., through multi-threaded processing, interrupt processing, or multiple processors, rather than sequentially.

In some examples, a computer-readable storage medium comprises a non-transitory medium. The term “non-transitory” indicates that the storage medium is not embodied in a carrier wave or a propagated signal. In certain examples, a non-transitory storage medium may store data that may, over time, change (e.g., in RAM or cache).

The technology discussed herein makes reference to servers, databases, software applications, and other computer-based systems, as well as actions taken and information sent to and from such systems. The inherent flexibility of computer-based systems allows for a great variety of possible configurations, combinations, and divisions of tasks and functionality between and among components. For instance, processes discussed herein may be implemented using a single device or component or multiple devices or components working in combination. Databases and applications may be implemented on a single system or distributed across multiple systems. Distributed components may operate sequentially or in parallel.

While the present subject matter has been described in detail with respect to various specific example embodiments thereof, each example is provided by way of explanation, not limitation of the disclosure. Those skilled in the art, upon attaining an understanding of the foregoing, can readily produce alterations to, variations of, and equivalents to such embodiments. Accordingly, the subject disclosure does not preclude inclusion of such modifications, variations and/or additions to the present subject matter as would be readily apparent to one of ordinary skill in the art. For instance, features illustrated or described as part of one example may be used with another example to yield a still further example. Thus, it is intended that the present

Various examples of the disclosure have been described. These and other examples are within the scope of the following claims.

What is claimed is:

1. A supervisor circuit comprising:
memory that stores configuration data for configuring programmable logic of a field programmable gate array (FPGA); and
logic circuitry configured to:
send, to the FPGA, the configuration data to enable the FPGA to write the configuration data to configuration memory of the FPGA to configure the programmable logic of the FPGA;
receive, from the FPGA, an indication of an error, detected during a data scrubbing operation, in the configuration memory of the FPGA;
determine, based on the indication of the error, a memory location in the configuration memory that contains the error; and
send, to the FPGA, error correction data for the memory location to correct the error contained in the memory location.

2. The supervisor circuit of claim 1, wherein the configuration data includes configuration information for configuring the programmable logic of the FPGA to include an error tracking function configured to track elapsed clock cycles since a start of the data scrubbing operation and to, in response to detecting the error in the configuration memory during the data scrubbing operation, send, to the supervisor circuit, the indication of the error in the configuration memory of the FPGA that includes an indication of a clock cycle count indicative of the elapsed clock cycles since the start of the data scrubbing operation.

3. The supervisor circuit of claim 2, wherein the error tracking function is further configured to periodically send a heartbeat to the supervisor circuit, wherein the logic circuitry is further configured to:
determine, based on the heartbeat received from the FPGA, that the error tracking function has been corrupted; and
in response to determining that the error tracking function has been corrupted, send, to the FPGA, the configuration data to enable the FPGA to rewrite the configuration data to the configuration memory of the FPGA to reconfigure the programmable logic of the FPGA.

4. The supervisor circuit of claim 2, wherein to determine, based on the indication of the error, the memory location of the error, the logic circuitry is further configured to determine, based on the clock cycle count, the memory location in the configuration memory that contains the error.

5. The supervisor circuit of claim 4, wherein to send, to the FPGA, the error correction data for the memory location, the logic circuitry is configured to:
determine a block of the configuration data stored in the memory that corresponds to the memory location; and
send the block of the configuration data stored in the memory that corresponds to the memory location to the FPGA to enable the FPGA to write the block of the configuration data stored in memory to the memory location in the configuration memory.

6. The supervisor circuit of claim 5, wherein the memory stores the configuration data in decrypted form, and wherein to send the block of the configuration data to the FPGA, the logic circuitry is further configured to:
decrypt, using a decryption key that corresponds to the block of the configuration data, the block of the configuration data stored in the memory that corresponds to the memory location.

7. The supervisor circuit of claim 4, wherein to determine, based on the clock cycle count, the memory location in the configuration memory that contains the error, the logic circuitry is further configured to:
determine, based on the clock cycle count and a number of clock cycles per memory location associated with FPGA, the memory location in the configuration memory that contains the error.

8. The supervisor circuit of claim 7, wherein to determine, based on the clock cycle count and the number of clock cycles per memory location associated with FPGA, the memory location in the configuration memory that contains the error, the logic circuitry is further configured to:
determine, based on dividing the clock cycle count by the number of clock cycles per memory location associated with the FPGA, the memory location in the configuration memory that contains the error.

9. The supervisor circuit of claim 7, wherein the logic circuitry is further configured to:
inject an intentional error in a specific memory location of the configuration memory;
in response to injecting the intentional error in the specific memory location of the configuration memory, receive, from the FPGA, a second clock cycle count indicative of elapsed clock cycles since a start of a second data scrubbing operation that detected the intentional error in the configuration memory; and
determine the number of clock cycles per memory location associated with the FPGA based on the second clock cycle count and the specific memory location of the configuration memory.

10. The supervisor circuit of claim 9, wherein to inject the intentional error in the specific memory location of the configuration memory, the logic circuitry is configured to:
inject the intentional error in an error detecting code associated with the specific memory location of the configuration memory.

11. The supervisor circuit of claim 4, wherein the indication of the error in the configuration memory of the FPGA comprises data stored in the memory location, and wherein to send, to the FPGA, the error correction data for the memory location, the logic circuitry is configured to:
determine a block of the configuration data stored in the memory that corresponds to the memory location;
determine an error correction code for the data stored in the memory location;
perform, using the error correction code, error correction of the data stored in the memory location to generate corrected data for the memory location; and
send the corrected data for the memory location to the FPGA to enable the FPGA to write the corrected data for the memory location to the memory location in the configuration memory.

12. A method comprising:
sending, by a supervisor circuit, configuration data to a field programmable gate array (FPGA) to enable the FPGA to write the configuration data to configuration memory of the FPGA to configure programmable logic of the FPGA;
receiving, by the supervisor circuit and from the FPGA, an indication of an error, detected during a data scrubbing operation, in the configuration memory of the FPGA;
determining, by the supervisor circuit and based on the indication of the error, a memory location in the configuration memory that contains the error; and
sending, by the supervisor circuit and to the FPGA, error correction data for the memory location to correct the error contained in the memory location.

13. The method of claim 12, wherein the configuration data includes configuration information for configuring the programmable logic of the FPGA to include an error tracking function configured to track elapsed clock cycles since a start of the data scrubbing operation and to, in response to detecting the error in the configuration memory during the data scrubbing operation, send, to the supervisor circuit, the indication of the error in the configuration memory of the FPGA that includes an indication of a clock cycle count indicative of the elapsed clock cycles since the start of the data scrubbing operation.

14. The method of claim 13, wherein the error tracking function is further configured to periodically send a heartbeat to the supervisor circuit, further comprising:
determining, by the supervisor circuit and based on the heartbeat received from the FPGA, that the error tracking function has been corrupted; and
in response to determining that the error tracking function has been corrupted, sending, by the supervisor circuit and to the FPGA, the configuration data to enable the FPGA to rewrite the configuration data to the configuration memory of the FPGA to reconfigure the programmable logic of the FPGA.

15. The method of claim 13, wherein determining, based on the indication of the error, the memory location of the error further comprises:
determining, by the supervisor circuit and based on the clock cycle count, the memory location in the configuration memory that contains the error.

16. The method of claim 15, wherein sending, to the FPGA, the error correction data for the memory location further comprises:
determining, by the supervisor circuit, a block of the configuration data stored in memory of the supervisor circuit that corresponds to the memory location; and
sending, by the supervisor circuit, the block of the configuration data stored in the memory that corresponds to the memory location to the FPGA to enable the FPGA to write the block of the configuration data stored in memory to the memory location in the configuration memory.

17. The method of claim 15, wherein determining, based on the clock cycle count, the memory location in the configuration memory that contains the error further comprises:
determining, by the supervisor circuit and based on the clock cycle count and a number of clock cycles per memory location associated with FPGA, the memory location in the configuration memory that contains the error.

18. The method of claim 17, further comprising:
injecting, by the supervisor circuit, an intentional error in a specific memory location of the configuration memory;
in response to injecting the intentional error in the specific memory location of the configuration memory, receiving, by the supervisor circuit and from the FPGA, a second clock cycle count indicative of elapsed clock cycles since a start of a second data scrubbing operation that detected the intentional error in the configuration memory; and
determining, by the supervisor circuit, the number of clock cycles per memory location associated with the FPGA based on the second clock cycle count and the specific memory location of the configuration memory.

19. The method of claim 18, wherein injecting the intentional error in the specific memory location of the configuration memory further comprises:
injecting, by the supervisor circuit, the intentional error in an error detecting code associated with the specific memory location of the configuration memory.

20. The method of claim 15, wherein the indication of the error in the configuration memory of the FPGA comprises data stored in the memory location, and wherein sending, to the FPGA, the error correction data for the memory location further comprises:
determining, by the supervisor circuit, a block of the configuration data stored in memory of the supervisor circuit that corresponds to the memory location;
determining, by the supervisor circuit, an error correction code for the data stored in the memory location;
performing, by the supervisor circuit and using the error correction code, error correction of the data stored in the memory location to generate corrected data for the memory location; and
sending, by the supervisor circuit, the corrected data for the memory location to the FPGA to enable the FPGA to write the corrected data for the memory location to the memory location in the configuration memory.
